(19) United States
(12) Patent Application Publication
(10) Pub. No.: US 2011/0029613 A1
(43) Pub. Date: Feb. 3, 2011

(54) EVALUATION OF AN ATTRIBUTE OF AN INFORMATION OBJECT

(76) Inventor: John Norman Hedditch, Western Australia (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/672,062

(22) PCT Filed: Aug. 1, 2008
(86) PCT No.: PCT/AU08/01119

§ 371 Date: Jun. 3, 2010

(30) Foreign Application Priority Data
Aug. 3, 2007 (AU) 2007904200

(51) Int. Cl. G06F 15/16

(52) U.S. Cl. 709/205

(57) ABSTRACT

Correspondents provide estimates of an attribute relating to an information object such as an online article on a particular topic. Correspondents also provide indications of their respective degree of trust of the estimates given by the other correspondents. An algorithm determines a network containing the estimates and degrees of trust and determines an overall estimate of the attribute from the point of view of any one correspondent in the network. A system of this kind is useful for rating websites, for example.

### CROSS REFERENCE TO RELATED APPLICATIONS

This application is a continuation-in-part application of the national phase entry of PCT/AU2008/001119 which is hereby incorporated by reference.

### TECHNICAL FIELD

The present invention pertains generally to information technology, the Internet, and more particularly to a method for estimating the veracity (or other attribute indicating informational value) of a piece of published information, article, review, document, written opinion, video recording, sound recording, or other ‘information object’.

### BACKGROUND

Computer databases, including networked ones such as are accessible via the World-Wide-Web (WWW), provide a vast repository of information. The advent of the Internet and search engines such as Google has made it easy for people to find information relating to more or less any area of human activity. There is, however, at present no convenient way of judging whether the information found is likely to be correct. Further, there is no convenient means for estimating (for example) the trustworthiness, competence or motives of the author or publisher of that information.

In the absence of such a mechanism, most people seeking confirmation of a judgment or purported fact will seek to read a number of opinions and attempt to find a consistent position within them. This is both time-consuming and prone to false conclusions where popular wisdom is false, where the true answer to a question is complex and counter-intuitive, or where misinformation predominates.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

### SUMMARY

In one broad aspect there is provided a system for presenting an information object to a requesting user, the system including a computerised system configured to:
receive, from one or more users, attribute data indicative of a personal estimate of an attribute of the information object;
receive, from at least some of the users, trust data indicative of a degree to which the respective user trusts one or more other users using the computerised system;
receive, from a requesting user whom is one of the one or more users, a request to be presented the information object;
determine, based upon the attribute data and the trust data, annotation data for annotating the information object; and
modify the information object according to the annotation data for presentation to the requesting user.

In one form, the computerised system receives, from the requesting user, network selection data to define a user network representing a selection of the one or more users of the computerised network, wherein the user network is used by the computerised network to determine the annotation data for modifying the information object for the requesting user.

In another form, the trust data received from one or more users selected in the requesting user's user network is used to indirectly determine the annotation data for modifying the information object for the requesting user.

In one embodiment, the computerised system is configured, in response to receiving the request to present the information object from the requesting user, to:
determine a rating of the information object based upon the trust data and the personal estimate of the attribute of the information object received from at least some of the one or more users of the requesting user's user network; and
present the rating of the object to the requesting user.

In another embodiment, the computerised system is configured to determine the rating of the information object using trust data and one or more personal estimates received from one or more indirect users defined within one or more user networks of one or more users selected within the requesting user's user network.

In an optional form, the computerised system receives the trust data and the attribute data via one or more user processing systems in data communication with the computerised system.

In another optional form, the computerised system includes:
a rewriter server configured to modify the information object according to the annotation data; and
a web server, in data communication with the rewriter server, which transfers data indicative of the information object, as modified by the rewriter server, to the requesting user via a web-browser being used at the respective user processing system of the requesting user.

In another broad aspect there is provided a method for presenting an information object to a requesting user, the method being performed by a computerised system, wherein the method includes, in the computerised system:
receiving, from one or more users, attribute data indicative of a personal estimate of an attribute of the information object;
receiving, from at least some of the users, trust data indicative of a degree to which the respective user trusts one or more other users using the computerised system;
receiving, from a requesting user whom is one of the one or more users, a request to be presented the information object;
determining, based upon the attribute data and the trust data, annotation data for annotating the information object; and
modifying the information object according to the annotation data for presentation to the requesting user.

In one form, the method includes, the computerised system, receiving, from the requesting user, network selection data to define a user network representing a selection of the one or more users of the computerised network, wherein the user network is used by the computerised network to determine the annotation data for modifying the information object for the requesting user.

In another form, the method includes the computerised system, using trust data received from one or more users selected in the requesting user's user network to indirectly determine the annotation data for modifying the information object for the requesting user.

In one embodiment, in response to receiving the request to present the information object from the requesting user, the method includes the computerised system:
determining a rating of the information object based upon the trust data and the personal estimate of the attribute of the information object received from at least some of the one or more users of the requesting user's user network; and
presenting the rating of the object to the requesting user.

In another embodiment, the method includes the computerised system determining the rating of the information object using trust data and one or more personal estimates received from one or more indirect users defined within one or more user networks of one or more users selected within the requesting user's user network.

In an optional form, the method includes the computerised system receiving the trust data and the attribute data via one or more user processing systems in data communication with the computerised system.

In another optional form, the computerised system includes a rewriter server in data communication with a web server, wherein the method includes:
the rewriter server modifying the information object according to the annotation data; and
the web server transferring information object data indicative of the information object, as modified by the rewriter server, to the requesting user via a web-browser being used at the user processing system by the requesting user.

In another broad aspect there is provided a computer program product including one or more programs for execution by one or more processors of a computerised system, wherein execution of the one or more programs enables the computerised system to present an information object to a requesting user, wherein the one or more programs includes instructions for:
receiving, from one or more users, attribute data indicative of a personal estimate of an attribute of the information object;
receiving, from at least some of the users, trust data indicative of a degree to which the respective user trusts one or more other users using the computerised system;
receiving, from a requesting user whom is one of the one or more users, a request to be presented the information object;
determining, based upon the attribute data and the trust data, annotation data for annotating the information object; and
modifying the information object according to the annotation data for presentation to the requesting user.

In one form, the computer program product configures the computerised system to receive, from the requesting user, network selection data to define a user network representing a selection of the one or more users of the computerised network, wherein the user network is used by the computerised network to determine the annotation data for modifying the information object for the requesting user.

In another form, the computer program product configures the computerised system to use trust data received from one or more users selected in the requesting user's user network to indirectly determine the annotation data for modifying the information object for the requesting user.

In one embodiment, the computer program product configures the computerised system to, in response to receiving the request to present the information object from the requesting user:
determine a rating of the information object based upon the trust data and the personal estimate of the attribute of the information object received from at least some of the one or more users of the requesting user's user network; and
present the rating of the object to the requesting user.

In another embodiment, the computer program product configures the computerised system to determine the rating of the information object using trust data and one or more personal estimates received from one or more indirect users defined within one or more user networks of one or more users selected within the requesting user's user network.

In an optional form, the computer program product configures the computerised system to receive the trust data and the attribute data via one or more user processing systems in data communication with the computerised system.

In another broad aspect there is provided a user processing system for allowing a requesting user to request presentation of an information object from a computerised system, the computerised system including attribute data indicative of one or more personal estimates of an attribute of the information object by one or more other users of the computerised system, wherein the user processing system is configured to:
transfer, to the computerised system, trust data indicative of a degree to which the requesting user trusts one or more of the other users of the computerised system;
transfer, to the computerised system, a request to be presented the information object;
receiving, from the computerised system, a modified version of the information object, wherein the information object has been modified using annotation data which is determined based upon the attribute data and the annotation data; and
presenting the modified version of the information object to the requesting user via the user processing system.

In one broad aspect there is provided a method, system, computer program product for improved estimation of the attribute or attributes of a person or thing (an ‘information object’), whereby an attribute we mean any property of an ‘information object’ which can be meaningfully assigned one of several different values. For example, where the ‘information object’ in question is a piece of data, an article, a review, a document, a written opinion, a video recording, a sound recording or any other ‘information object’, the attribute or attributes to be estimated might be, to pick some examples, ‘veracity’, or ‘authenticity’ or ‘usefulness’.

In one aspect there is provided a system for determining an attribute of an information object, including: a means for multiple correspondents to specify a personal estimate for said attribute, a means for each correspondent to specify a degree to which they trust one or more other correspondents' personal estimates of said attribute; and a networking means which generates a graph of said personal estimates and degrees of trust, and from the graph determines a list of estimates of said attribute as perceived by any of the correspondents.

Compared to simplistic voting techniques, this invention is robust against ‘flooding’ attacks, where a large number of computer-controlled participants are involved. Within the context of the invention, such automated participants are unlikely to be assigned a significant trust rating by other participants, and thus will not contribute noticeably to the rankings of content.

The invention may involve three subsystems. The first subsystem enables an ‘information object’ to be uniquely identified. The second enables a person to make a personal estimate for the value of an attribute of an ‘information object’. (A personal estimate means an estimate that is independent of other such estimates). The third subsystem enables a calculated estimate of the value of an attribute of an ‘information object’ to be obtained by a second person through the use of the first two mechanisms.

Preferably the means of identifying an ‘information object’ is through the correspondence of a stored number with the result of the application of a cryptographic hash (digest) function which maps a collection of predetermined elements of that ‘information object’ to a number. Preferably the collection of predetermined elements includes the user-visible content where the thing is a document, ensuring that if a document is modified it will not inherit the ratings attached to the previous version. Preferably where that ‘information object’ to be identified is a person, the collection of elements includes the name of the person and an additional identifier, such as their email address, the purpose of the additional identifier being to ensure unique identification of the person so that personal estimates made by different people of the same name are not conflated.

Preferably the means of specifying a personal estimate is by voting on a given attribute. Preferably the means of specifying a personal estimate is through providing a rating, such a rating being a number held to be relative to a perfect score, e.g. 3 out of 5, 7 out of 10, or a number of “stars” e.g. 3 “stars” out of 5 “stars” or any similar scheme. Where the personal estimate is for the trustworthiness of another person, the estimate defines a value of ‘partial trust’ for that person.

Preferably the means of evaluating an attribute of an ‘information object’ is through the application of an algorithm to a mesh or graph or network of data comprising ‘partial trusts’ between correspondents and the ‘personal’ estimates all these people have assigned to the ‘information object’ of interest, where they have done so. This network of partial trusts is formed through the second mechanism described above. Preferably this algorithm can produce from the network of said partial trusts and the personal estimates of other correspondents a list containing candidate estimates for said attribute as perceived by a given correspondent. Preferably each estimate is annotated with the given correspondents' evaluated trust for the estimate.

Examples of possible algorithms of this type can be found in FIGS. 6 and 7. Preferably the algorithm may make use of a function that reduces this list to a single estimate. Preferably the function may also calculate the uncertainty of this estimate. Alternatively, the function may simply calculate a number.

Preferably the algorithm is as follows:

1. Start with two queues, q and c. a list l, and a variable should stop.

2. Set should stop to False

3. Populate q with tuples (u,v) where u is a correspondent for whom your partial trust is non-zero and v is your trust rating for that user. Let such a collection be called a cabal.

4. While q is not empty

remove the first element from the queue. Denote this tuple (r,s). If r has an estimate for said attribute, add the tuple (s,e), where e is r's estimate to the list l and set should stop to True.

mark r as visited

for each user and rating (o,m) in r's cabal

if o is not marked as visited add (o,n) to c, where n=s*m.

if q is empty:

if should stop is False swap q and c

5. return l

Alternatively the algorithm is as follows:

1. start with two lists, k and l.

2. Populate k with tuples (u,v) where u is a correspondent for whom your partial trust is non-zero and v is your trust rating for that user.

3. for each (u,v) in k if u has an estimate e for said attribute, add (v,e) to the list l.

4. return l

Preferably the list-reducing function is the linear-least-squares estimate of the values in the list. The list-reducing function may be the maximum or minimum of the values in the list. In one instance the list-reducing function is the median value of l. In one instance the list-reducing function is the root-mean-square average of the values in the list.

In another aspect the invention resides in a method for estimating an attribute of an information object, including: receiving personal estimates regarding the attribute from one or more correspondents, receiving trust indications representing the degree to which each correspondent trusts a personal estimate of another correspondent, generating a network of personal estimates and degrees of trust, and determining from the network one or more estimates of said attribute as perceived by any of the correspondents.

Preferably the means of specifying partial trusts is through said correspondent to manually assign to other correspondents a rating.

Preferably the algorithm is as follows:

1. Start with two queues, q and c. a list l, and a variable should stop.

2. Set should stop to False

3. Populate q with tuples (u,v) where u is a correspondent for whom your partial trust is non-zero and v is your trust rating for that user. Let such a collection be called a cabal.

4. While q is not empty

remove the first element from the queue. Denote this tuple (r,s). If r is associated with said attribute, add s to the list l and set should stop to True.

mark r as visited

for each user and rating (o,m) in r's cabal

if o is not marked as visited add (o,n) to c, where n=s*m.

if q is empty:

if should stop is False swap q and c

5. return l

Alternatively the algorithm is as follows:

1. Start with two queues, q and c. a list l, and a variable should stop.

2. Set should stop to False

3. Populate q with tuples (u,v) where u is a correspondent for whom your partial trust is non-zero and v is your trust rating for that user. Let such a collection be called a cabal.

4. While q is not empty

remove the first element from the queue. Denote this tuple (r,s). If r is associated with said attribute, return l.

mark r as visited

for each user and rating (o,m) in r's cabal

if o is not marked as visited add (o,n) to c, where n=s*m.

if q is empty:

if should stop is False swap q and c

In a further aspect the invention resides in a rating system for websites, including: a means for multiple correspondents to provide website ratings, a means for each correspondent to specify a degree to which they trust ratings provided by other correspondents; and a networking means which generates a network of the ratings and degrees of trust in relation to a selected website, and from the network determines a rating for the website as perceived by any one of correspondents in the network.

In another aspect there is provided a system for determining an attribute of an information object, including:
a means for multiple correspondents to specify a personal estimate for said attribute,
a means for each correspondent to specify a degree to which they trust one or more other correspondents' personal estimates of said attribute; and
a networking means which generates a network of said personal estimates and degrees of trust, and from the network determines one or more estimates of said attribute as perceived by any of the correspondents;
wherein the means for correspondents to specify the personal estimates is configured to modify the information object for presentation to one of the correspondents using the one or more estimates of said attribute as perceived by the respective correspondent.

In one form, the means for correspondents to provide website ratings includes a web application which rewrites third-party web-pages and adds controls through which the ratings are submitted.

In another form, the means for correspondents to provide website ratings includes a web application which rewrites third-party web pages and adds controls through which a rating determined by the network means can be viewed.

In another aspect there is provided a method for estimating an attribute of an information object, including:
receiving personal estimates regarding the attribute from one or more correspondents,
receiving trust indications representing the degree to which each correspondent trusts a personal estimate of another correspondent,
generating a network of personal estimates and degrees of trust,
determining from the network one or more estimates of said attribute as perceived by any of the correspondents; and
modifying the information object for presentation to one of the correspondents using the one or more estimates of said attribute as perceived by the respective correspondent.

In one form, modifying the information object includes adding controls through which the ratings are submitted.

In another form, modifying the information object includes adding controls through which a rating determined by the network means can be viewed.

In another aspect there is provided a rating system for websites, including:
a means for multiple correspondents to provide website ratings,
a means for each correspondent to specify a degree to which they trust ratings provided by other correspondents; and
a networking means which generates a network of the ratings and degrees of trust in relation to a selected website, and from the network determines a rating for the website as perceived by any one of correspondents in the network;
wherein the means for correspondents to specify the personal estimates is configured to modify the selected website for presentation to one of the correspondents using the rating for the website as perceived by the respective correspondent.

The invention also resides in any alternative combination of features that are indicated in this specification. All equivalents of these features are deemed to be included whether or not explicitly set out.

In all aspects of the present invention, references to correspondents mean any entity that may communicate with another entity. These include: humans, software agents, measuring apparatus such as thermometers or mass spectrometers, or animals.

Throughout this document it should also be understood that the term “attribute” means any property of an ‘information object’, to which meaningfully assign one of several different values.

### LIST OF FIGURES

Embodiments of the invention will be described by way of example with reference to the accompanying drawings, in which:

FIG. 1A illustrates a functional block diagram of an example processing system that can be utilised to embody or give effect to one or more particular embodiments;

FIG. 1B is a system diagram of a web application allowing users to rate and evaluate web pages;

FIG. 2 is a system diagram for a web application which allows users to browse and rate third-party websites, as well as to receive recommendations of further sites to view;

FIG. 3 is a system diagram for a web application which rewrites third-party websites in order to augment them with indicators of the ratings generated by the present invention;

FIG. 4 is a system diagram for a web application which rewrites third-party websites in order to augment them with both indicators and controls pertaining to the present invention;

FIG. 5 is a system diagram for a web-browser plugin;

FIG. 6 is a schematic diagram of a network or graph of partial trusts between correspondents;

FIG. 7 is a schematic diagram showing the directed acyclic graph of shortest paths connecting ‘Alice’ to a value;

FIG. 8 is a schematic diagram showing the directed acyclic graph of shortest paths connecting ‘George’ to a value;

FIG. 9 is a flowchart showing the top-level algorithm for a website using the invention claimed below;

FIG. 10 is a flowchart establishing how to obtain a rating for a piece of content in the website of FIG. 4;

FIG. 11 is a flowchart showing an algorithm for using a cabal (a plurality of partially-trusted intermediaries) to provide estimated ratings for a piece of content, e.g. in FIG. 5;

FIG. 12 is a flowchart showing an alternative algorithm which returns estimated ratings in a different form;

FIG. 13 is a flowchart showing the top-level algorithm for a web application;

FIG. 14 is a screenshot illustrating an example of the basic user-visible elements of the web application of FIG. 13;

FIG. 15 is a screenshot illustrating an example of the basic user-visible elements of the web application of FIG. 13 where the user has chosen to display the page controls;

FIG. 16A is a block diagram illustrating an example of a computerised system;

FIG. 16B is a flowchart representing a method performed by the computerised system of FIG. 16A;

FIG. 17 is a screenshot of a web-browser including an example of an interface presented at the user processing system for presenting the information object;

FIG. 18A to 18E is a flowchart representing an example of a method performed by the a control server of the computerised system of FIG. 16A; and

FIG. 18F is a flowchart representing an example of a method performed by a rewriter server of the computerised system of FIG. 16A.

### DESCRIPTION OF PREFERRED EMBODIMENTS

Referring to the drawings it will be appreciated that the invention can be implemented in a range of different forms, and that these embodiments are given by way of example only. The invention is typically implemented over the Internet using otherwise conventional computers and communication systems.

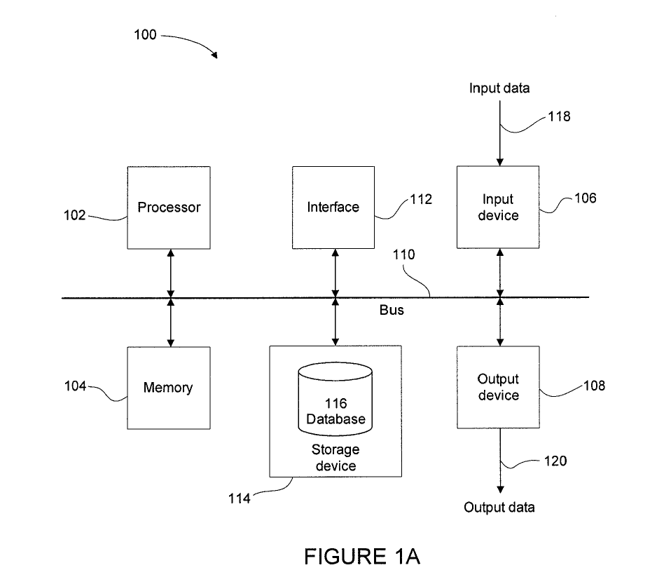

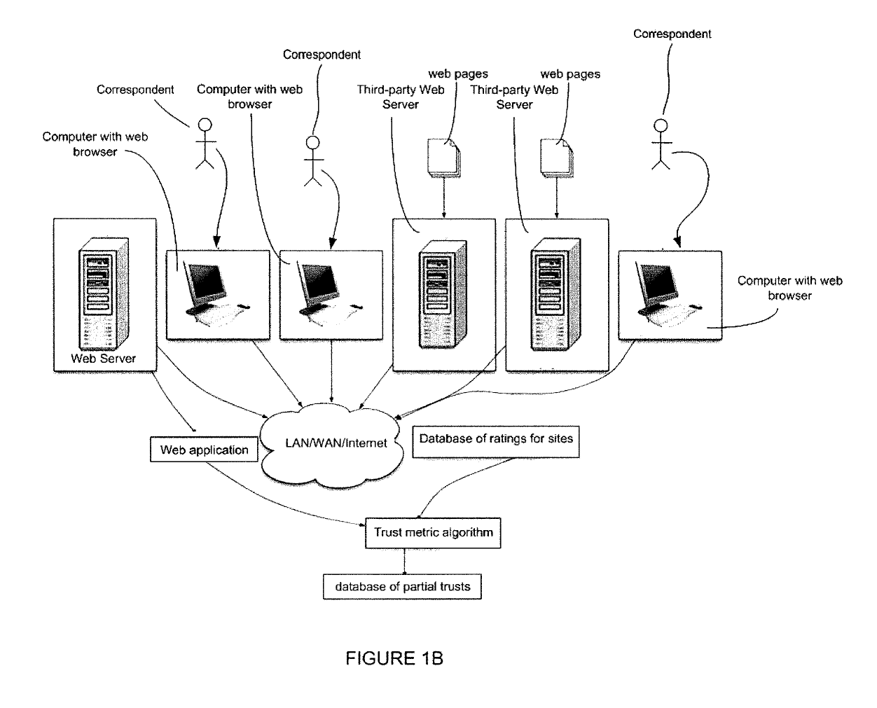

A particular embodiment can be realised using a processing system, an example of which is shown in FIG. 1. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 also can be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116 and/or the memory 104. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

FIG. 1B schematically shows an embodiment in which a web application allows users to rate and evaluate web pages. A database is created containing ratings of a wide range of information objects, primarily web pages, which have been reviewed by correspondents. The box labeled ‘Trust Metric algorithm’ contains one or more algorithms as described below which uses the ratings to create a database of partial trusts.

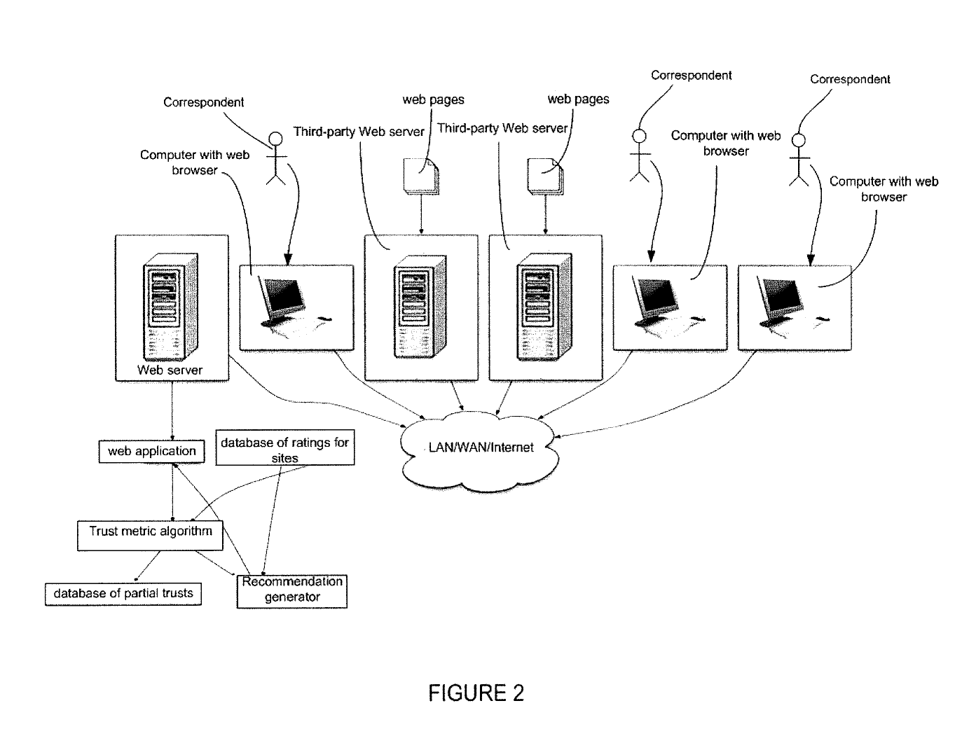

In FIG. 2 a further embodiment involves a web application which additionally allows users to browse and rate third-party web sites, and where the rankings calculated according to the method described herein are used to generate recommendations for further browsing.

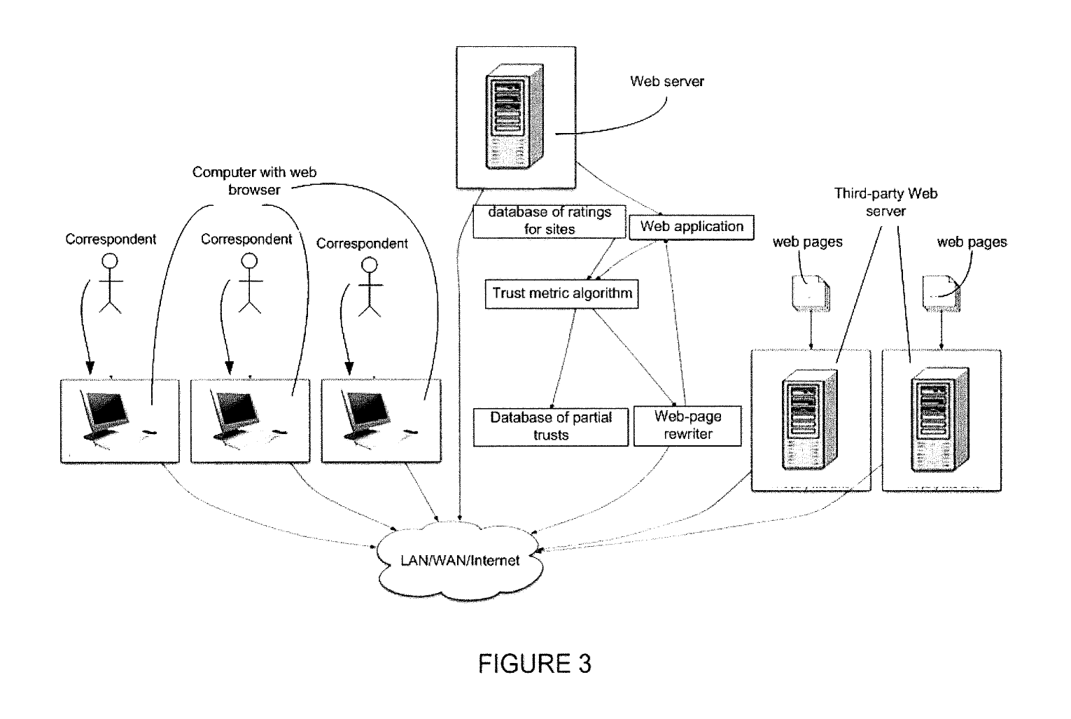

A further embodiment shown in FIG. 3 involves a web application which rewrites third-party web-pages in order to augment them with indicators of the ratings generated by the present invention. A key component of this embodiment is the ‘page rewriter’ component shown which is responsible for modification of the third-party web-pages.

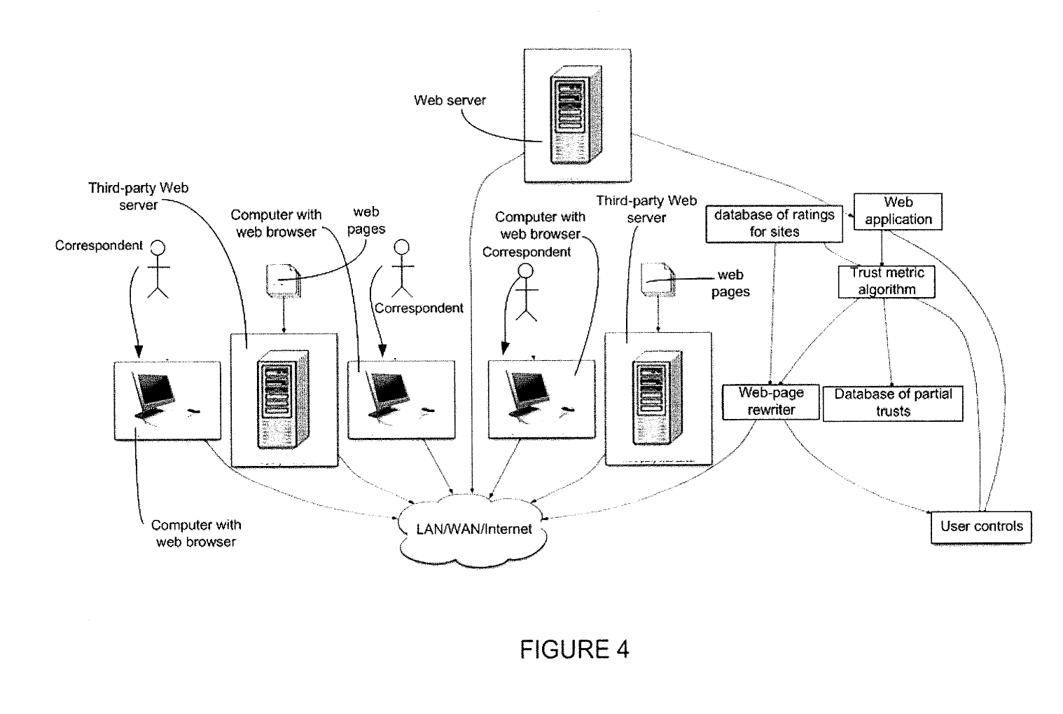

As shown in FIG. 4, a further embodiment involves a web-based application which rewrites third-party web-pages in order to augment them with both indicators of the ratings generated by the present invention and also with controls through which a visitor to the site may submit an estimate or modify their partial trusts for other users.

In these embodiments, hypertext links in external pages are replaced with links which request the embodiment to display a rewritten version of the target of the original link, and interactive elements of the page such as forms, are rewritten such that they submit their data to the embodiment, which may inspect the contents and respond appropriately, either by forwarding the request and displaying a rewritten result or by responding directly.

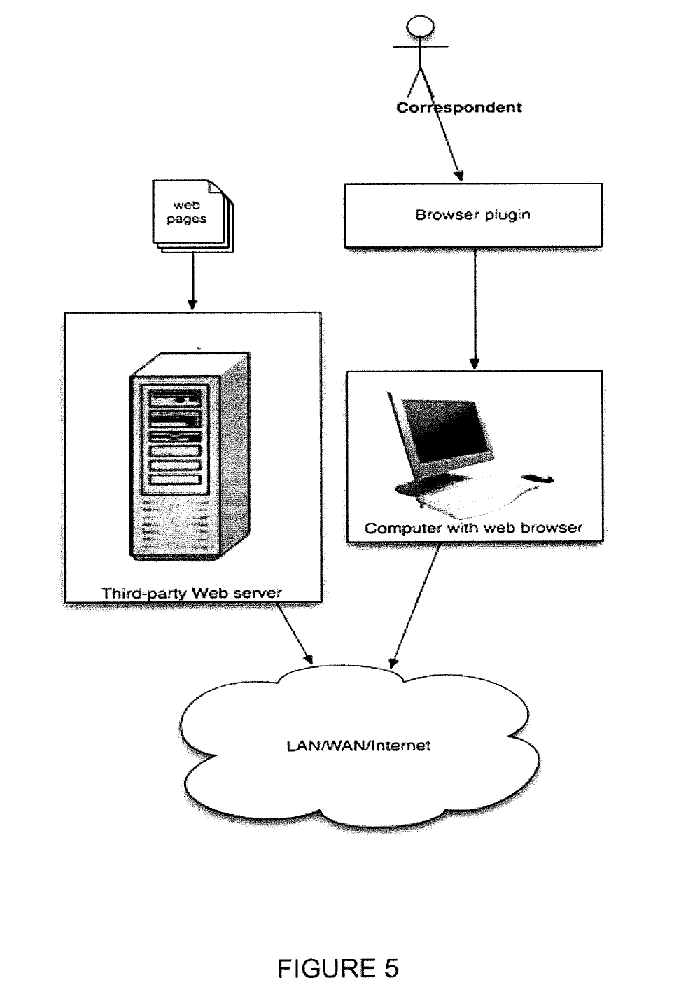

A further embodiment shown in FIG. 5 is a “plugin” software component for a web-browser which provides the user with an estimate of the trustworthiness (or other attribute) of a hypertext reference (a link) or a website, based on a function of other user's opinions.

This embodiment may provide this information by means of a graphical or textual representation of the inferred trust in the web-browsers interface, or in the page rendered. Two distinct interfaces are considered. The first interface consists of a textual or iconic representation of trust (such as a smiling or sad face, or a percentage rating), which is displayed in the status bar of the web browser. The second interface consists of displaying such a textual or representation as a box containing text and/or images which is displayed beside the mouse cursor when the cursor spends more than a pre-defined time hovering over a hypertext link.

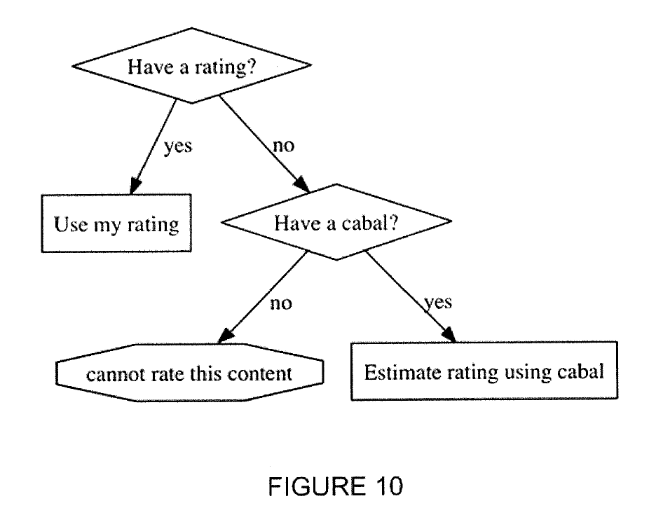

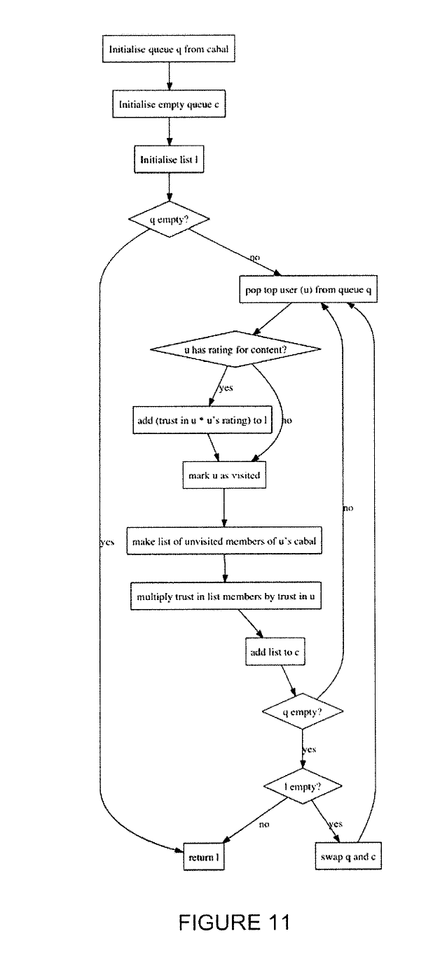

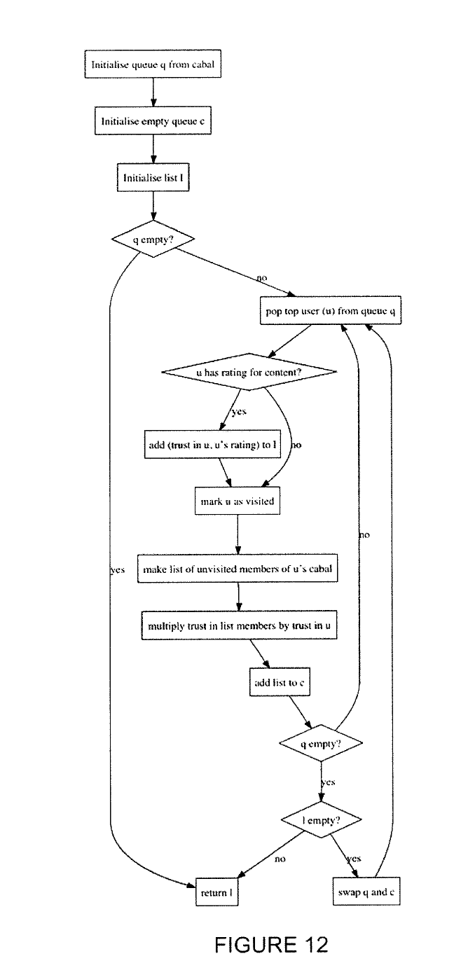

As in the initial practical embodiment, the estimate is obtained through algorithms such as those in FIG. 11 and FIG. 12. A system diagram for this embodiment is shown in FIG. 10.

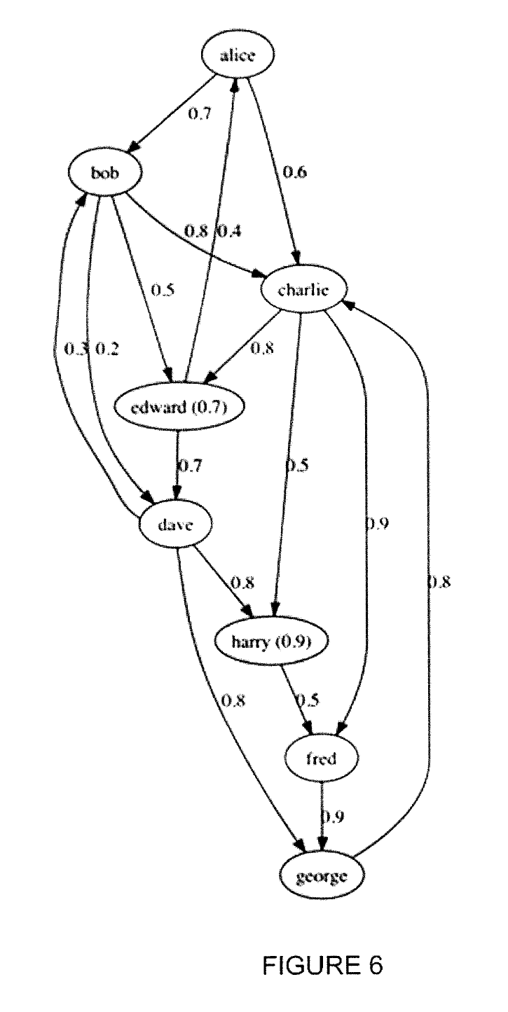

In FIG. 6, a graph, representing a network of partially trusted intermediaries is depicted. Individual users are represented by circles. An arrow from an individual A to another individual B represents the weight that A attaches to the opinion of B, which in the diagram is normalised to lie between 0 (no weight) to 1 (the same weight as A's own opinion). Each individual may also possess an opinion about a subject or piece of information, which is shown in the picture as a value stored within a circle. With reference to previous sections, these link weights define partial trusts.

A further embodiment is a web site which uses the first, second and third devices to evaluate a multiplicity of information sources and filter the output according to the trustworthiness or other attribute of the result. In this way the site can present to each user a personalised set of top-rated articles, reviews or other ‘information objects’.

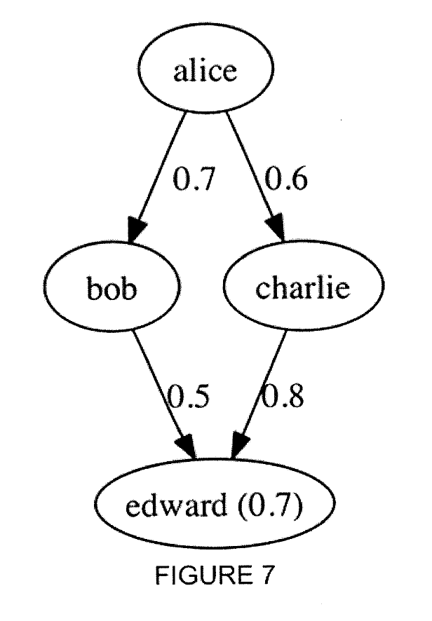

In FIG. 7, we show the shortest paths linking the entity ‘Alice’ to the entity ‘Edward’. Two such paths exist: Alice->Charlie->Edward and Alice->Bob->Edward. It is important to note that in general there will be no symmetry present—the shortest path from ‘Edward’ to ‘Alice’ is simply Edward->Alice. This asymmetry is in general necessary because whilst an individual A may regard another individual B as an expert, or someone whose opinion is to be highly regarded, this does not imply that B would regard A as an expert. Here Edward is two hops away from Alice, but Alice is only 1 hop away from Edward.

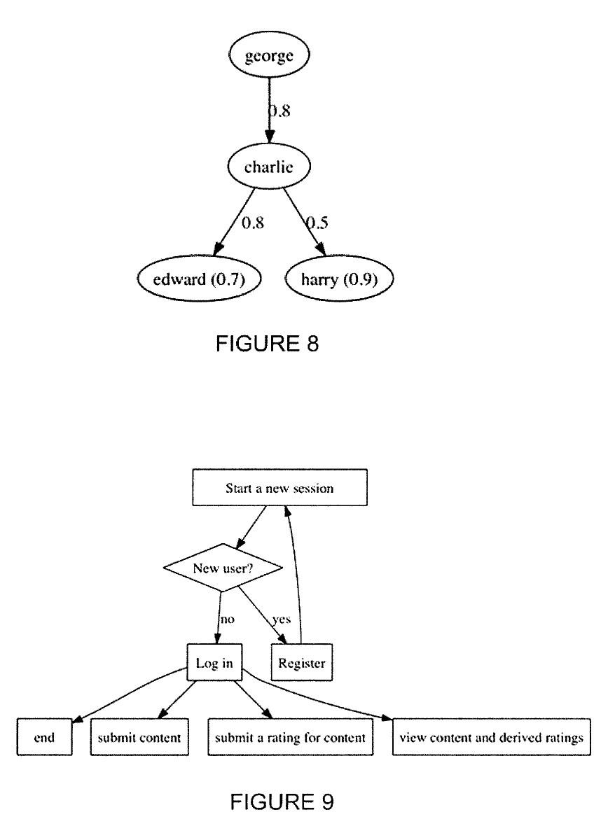

In FIG. 8, we show the shortest paths linking the entity ‘George’ to an opinion. Two such paths exist: George->Charlie->Edward, and George->Charlie->Harry. There is a pronounced asymmetry here. In order to obtain an estimated opinion/ranking, George must consult at least two other individuals (Charlie, and either Edward or Harry), but either of Edward or Harry can simply refer to their own established opinion. Put another way, George is two hops away from an opinion, whereas Edward and Harry are zero hops away from an opinion.

FIG. 9 shows a high-level logic flow for such a website. Upon connecting to the website, the user may register (create an account), or log in to an existing account. If the user chooses to register a new account, they will afterwards be able to log in to this account. Having logged in, users will be provided with an interface through which they can submit content, search or browse for content submitted by themselves or others, vote on content, and specify their opinion of other users. The specification of the user's opinion of other users may take the form of choosing friends and declaring them to be ‘extremely close’, ‘very close’, ‘close’, ‘moderate’, or ‘distant’ friends, or other such labels.

FIG. 10 provides an example top-level algorithm for ranking a subject (piece of information). First, the user should check to see whether they have voted on the subject in the past. If so, the value corresponding to that vote should be used as the rank for that subject. If this is not the case, the user should check to see whether there are any other users for which they have a non-zero trust—this group is that user's ‘Cabal’ or the user's network. If such a group does not exist, no estimate can be made for the rank of the subject. If such a group does exist, then the graph database, as will be discussed in more detail below, can make use of these users to estimate a rank. Sample algorithms for making such an estimate are given in FIG. 11 and FIG. 12.

FIG. 11 shows a possible algorithm for inferring a rank from a ‘cabal’ of partially trusted intermediaries. The algorithm calculates the shortest paths connecting the user seeking a rank to an entity which possesses an opinion on the item to be ranked, keeping a list of multiplied trust-values along the way. A function such as the linear or RMS average of the returned list will provide an estimate for the rank.

This algorithm proceeds as follows:

1. Start with two queues, q and c. a list l, and a variable should stop.

2. Set should stop to False

3. Populate q with tuples (u,v) where u is a correspondent for whom your partial trust is non-zero and v is your trust rating for that user. Let such a collection be called a cabal.

4. While q is not empty

remove the first element from the queue. Denote this tuple (r,s). If r has an estimate for said attribute, add the product of s and their estimate to the list l and set should stop to True.

mark r as visited

for each user and rating (o,m) in r's cabal

if o is not marked as visited add (o,n) to c, where n=s*m.

if q is empty:

if should stop is False swap q and c

5. return l

FIG. 12 shows another possible algorithm for inferring a rank from a ‘cabal’ of other partially trusted entities. The algorithm calculates the shortest paths connecting the user seeking a rank to an entity which possesses an opinion on the item to be ranked, keeping the multiplicative trust values and the opinions as separate entities in a list of results. A function of this result list is used to obtain an estimate of the attribute of the item. An example of such a function would be a linear average, or a chi-squared fit, using a function of the trust values as uncertainties. In this example, the algorithm multiplies trusts along the path, but many other functions (sum, min, max, etc) could be used in the place of this multiplication.

This algorithm proceeds as follows:

1. Start with two queues, q and c. a list l, and a variable should stop.

2. Set should stop to False

3. Populate q with tuples (u,v) where u is a correspondent for whom your partial trust is non-zero and v is your trust rating for that user. Let such a collection be called a cabal.

4. While q is not empty remove the first element from the queue. Denote this tuple (r,s). If r has an estimate m for said attribute, add the tuple (s, m) to the list l and set should stop to True.

mark r as visited

for each user and rating (o,m) in r's cabal

if o is not marked as visited add (o,n) to c, where n=s*m.

if q is empty:

if should stop is False swap q and c

5. return l

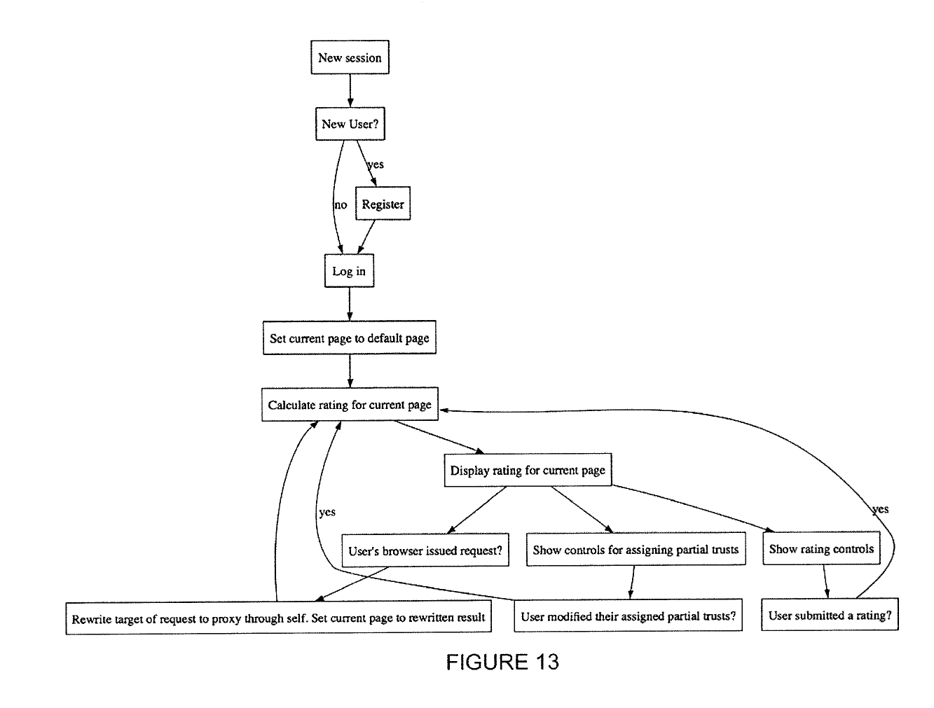

In FIG. 13, we show the top-level logic for a web-based application which allows users to browse and rate third-party web sites, and where the rankings calculated according to the method described herein are used to generate recommendations for further browsing. Page rankings are calculated using the contents of the original (pre-rewriting) external web-pages. When rewriting pages, the application may make use of the algorithms described above to selectively edit or remove elements of the target pages. For example, where a user's derived estimate for a hypertext link is below a chosen threshold, the application may render the link into simple text during the page-rewriting process.

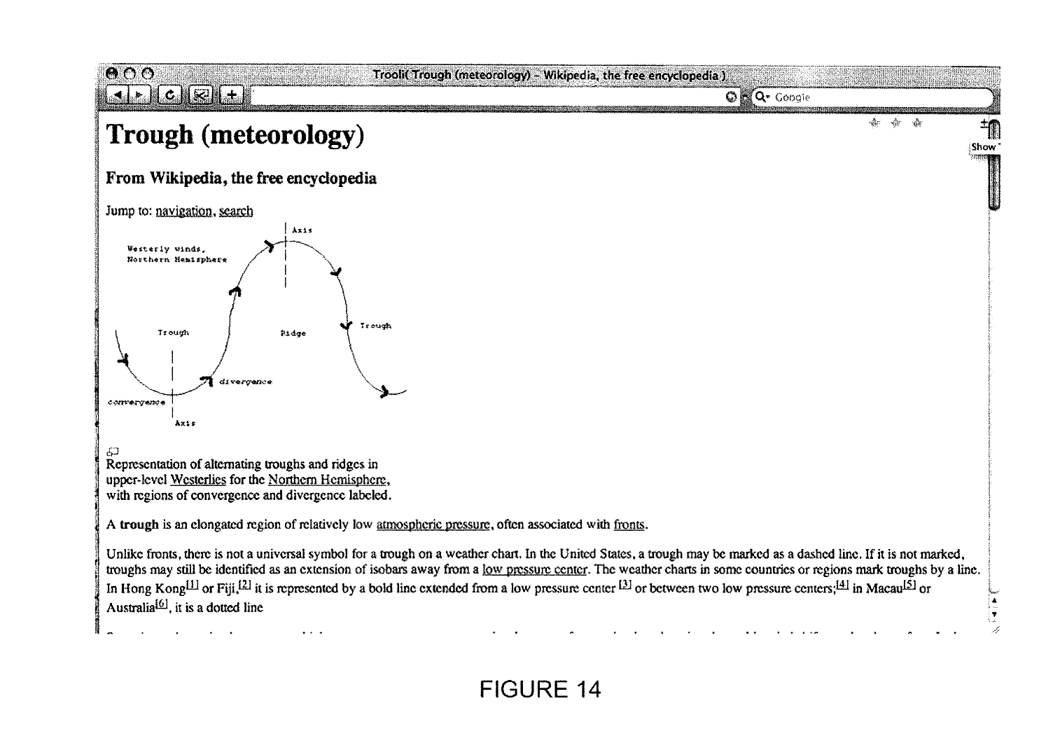

In FIG. 14, we show a screenshot illustrating the basic user-visible elements of the web application of FIG. 13 where the user is viewing a third-party page. The stars in the top right corner indicate the derived rating for this page (in this case, 3 out of 5).

A personal estimate can be submitted by simply clicking on a star. The plus symbol is a link which when clicked on, presents further controls to the user. Clicking on any of the links shown will cause the browser to request the web application to display the (rewritten) page corresponding to that link.

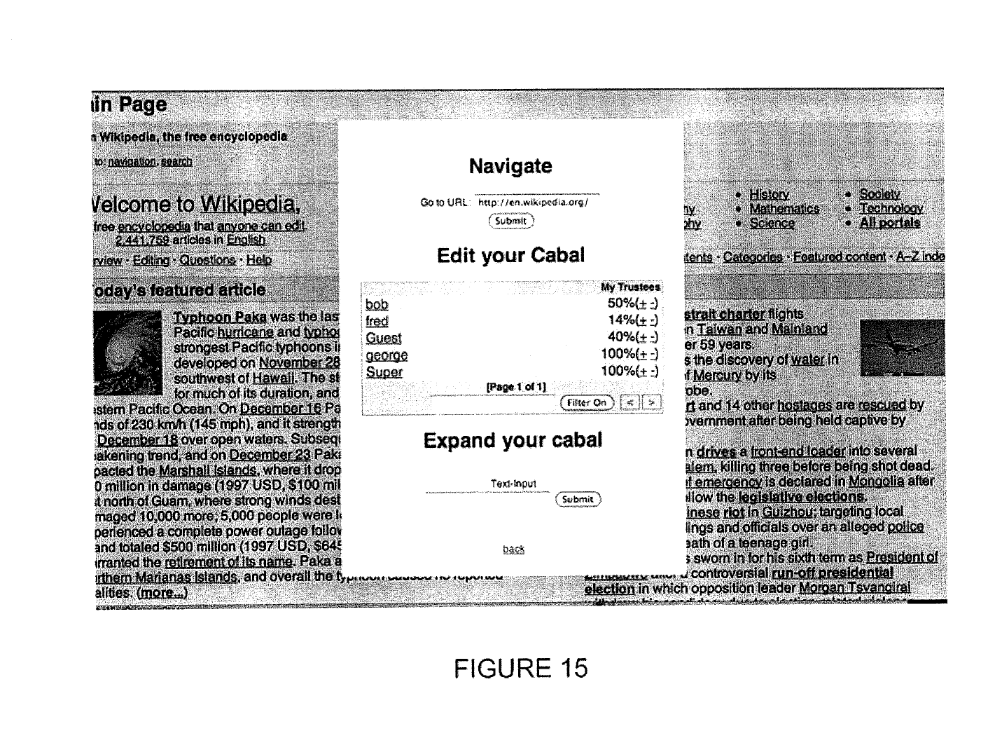

In FIG. 15, we show screenshot illustrating the basic user-visible elements of the web application of FIG. 13 where the user has chosen to display the page controls. Here the user has the option to request that the web application display a new page, to edit their partial trusts or to return to browsing.

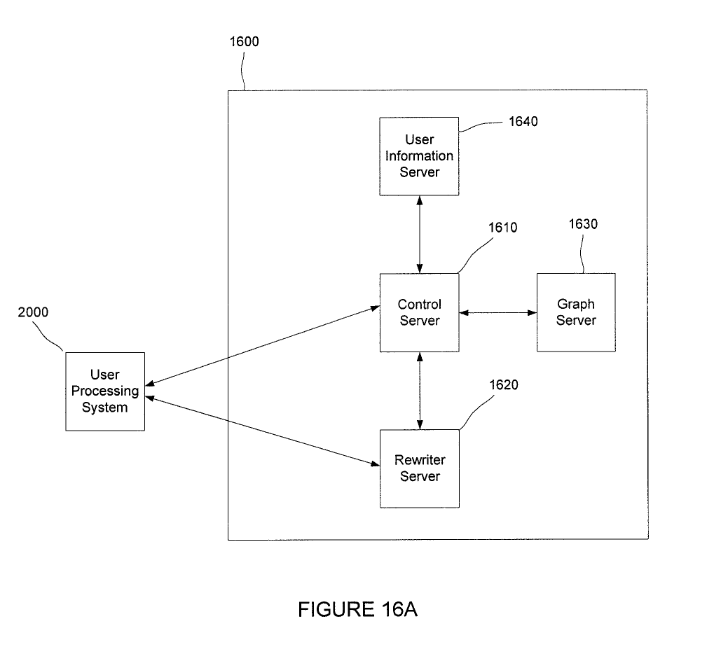

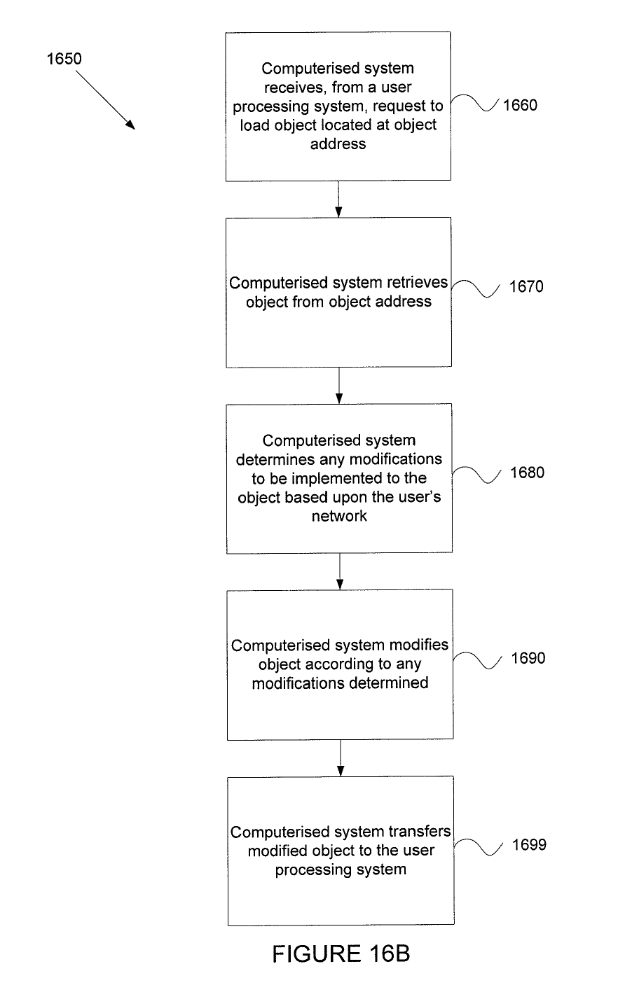

Referring to FIG. 16A there is shown an example of a computerised system for implementing the method and system described above.

In particular, the computerised system 1600 includes a control server 1610, a rewriter server 1620, a graph server 1630, and a user information server 1640. The servers may be implemented via separate server processing systems in the form of a distributed computerised network. Alternatively, the computerised system 1600 can be implemented using a single processing system, or more than one processing system, which is logically separated to define the servers and configured to perform the functions herein described. The computerised system can utilise one or more processing systems 100 as discussed in relation to FIG. 1A.

As shown in FIG. 16, the control server 1610 is in data communication with the rewriter server 1620, the graph server 1630 and the user information server 1640. However, the rewriter server 1620, the graph server 1630 and the user information server 1640 are not necessarily in direct communication with each other but rather potentially communicate indirectly via the control server 1610 which can then determine whether the respective servers can communicate or restrict the communication. As such, this configuration provides some significant security advantages to prevent malicious activities being performed by the respective servers.

As shown in FIG. 16, a user processing system 2000 can interact with the computerised system 1600 via a web-browser which is able to receive and transfer data to and from the control server 1610 and the rewriter server 1620.

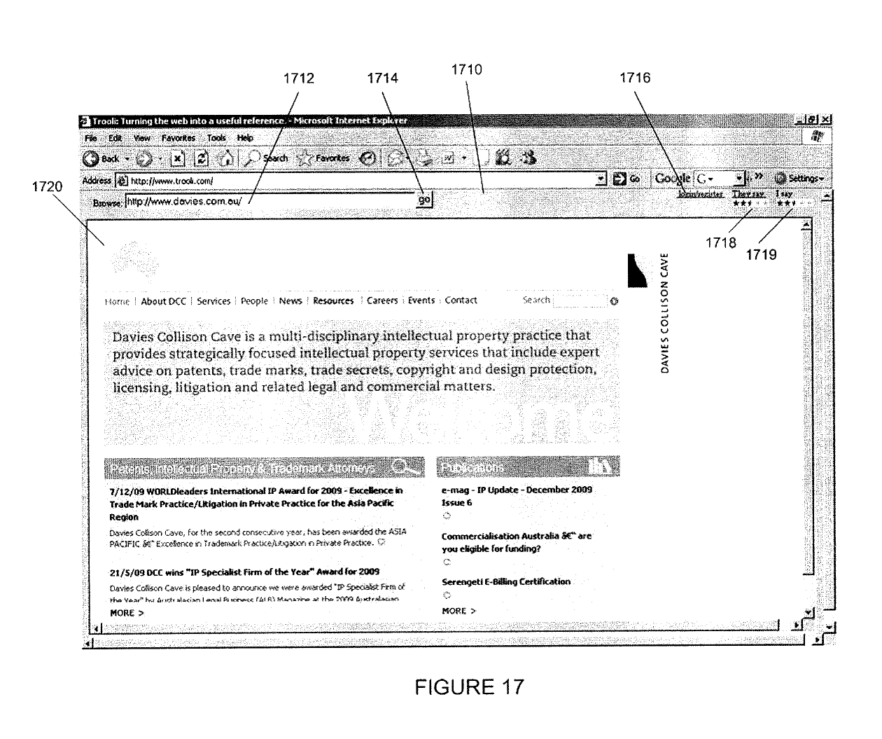

The control server 1610 includes a webserver 1612 configured to present a first interface portion 1710 via the user's web-browser 1700. The rewriter server 1620, as previously discussed, is configured to rewrite at least a portion of the object according to a rating determined based upon the network for the respective user. In addition, the rewriter server 1620 is configured to present a second interface portion 1720 via the user's web-browser 1700 to the user. In one form, as shown in FIG. 17, the first interface portion 1710 is presented as a container frame of a webpage and the second interface portion 1720 is presented as an internal frame of the webpage, wherein the internal frame is presented within the container frame.

The first interface portion 1710 includes a plurality of interface controls which can be interacted with by the user and controlled by the control server 1610 via the webserver 1612. The interface controls can include an object address field 1712 for inputting and displaying the address of the object being requested or presented. The object address field 1712 presents the object address in the object address field in the form of text. A button 1714 is located adjacent the object address field which allows the user to execute the retrieval of the object located at the object address inputted in the object address field 1712. As shown in FIG. 17, the object address may be provided in the form of a URL (Uniform Resource Locator). In some instances, as will be discussed in more detail, the control server 1610, via the webserver 1612, can set the object address presented in the object address field 1712.

The interface controls can also include a rating indicator 1718, 1719 which, as shown in FIG. 17, is presented in the form of a graphical indicator, such as number of stars indicative of the rating associated with the object based on the user's defined network. The rating indicator 1718, 1719 includes two sections, a first rating indicator portion 1718 indicative of the user's previously submitted rating of the object being presented via the web-browser 1700, and a second rating indicator portion 1719 indicative of the calculated perceived rating by the network associated with the user. The user is able to interact with the first rating indicator portion 1718 to submit a rating for the presented object which is then transferred to the graph server for processing and recording. The user can interact with the second trust indicator 1719 to adjust the user's network such as adding or removing members of the user's network.

The interface controls can also include a login and/or logout control 1716 to allow the user to securely login and logout of the computerised system 1600.

Continuing with FIG. 17, the second interface portion 1720 presents a modified version of the object. As shown in the example screenshot of FIG. 17, the object can be a website located at the URL displayed in the object address field 1712 of the first interface portion 1710, wherein the second interface portion 1720 presents a modified version of the website. It will be noted that the URL bar 1730 of the web-browser 1700 is the address of the webserver 1612 of the control server 1610. When a user continues to request further objects using the computerised system 1600, the object address field 1712 of the first interface portion 1710 may be adjusted by the control server 1610, however, the URL bar 1730 of the web-browser 1700 remains unchanged.

The rewriter server 1620 can be provided in the form of a suffix proxy which modifies objects requested by the user. The modifications performed by the rewriter server 1620 can occur for two purposes: firstly to ensure that browsing within the internal frame 1720 can be tracked by the control server 1610; and secondly to modify the object according to the user's network.

The graph server 1630 can include a graph database including data indicative of the network for each user of the computerised system 1600. The graph database can also include attribute values for each user of the computerised system for various information objects. The graph database can also include the associated trust values assigned by the user for each member in the user's network. The graph server 1630 can also execute a number of functions to perform processing on the graph database. For example, the graph server can include a function to implement the shortest path function described above. The graph database functions can be accessible by the control server, wherein the control server can pass a request to the graph server to perform one or more of the database functions. The graph server 1630, upon performing one or more of the database functions, may return result data to the control server 1610 in response to the execution of the one or more graph database functions.

The user information server 1640 can include a user information database which stores user annotation data for various information objects, wherein the user annotation data is indicative of modifications submitted by users of the computerised system 1600 for the various information objects. The user information server 1640 also stores within the user information data user login information. The user information server 1640 can also execute a number of functions to perform processing on the user information database. The user information database functions can be accessible by the control server, wherein the control server can pass a request to the user information server to perform one or more of the database functions. The user information server 1640, upon performing one or more of the database functions may return result data to the control server 1610 in response to the execution of the one or more database functions.

It will be appreciated that the user information server 1640 and the graph server 1630 have been logically separated in order to process data more efficiently and effectively. However, it is possible that the graph server 1630 and the user information server 1640 could be provided as a single data server which includes a database for performing the function of both the graph database and the user information database.

Referring to FIG. 16B there is shown a flowchart 1650 representing a general method performed by the computerised system 1600 of FIG. 16A for implementing the method and system described above.

In particular, at step 1660, the method includes the computerised system 1600 receiving a request, from a user processing system 2000 operated by a user, to present an object located at an object address. At step 1670, the method includes the computerised system 1600 retrieving the object at the object address. At step 1680, the method includes the computerised system 1600 determining one or more modifications to the network based upon the user's network. At step 1690, the method includes the computerised system 1600 modifying the object according to the one or more modifications. At step 1699, the method includes the computerised system 1600 transferring the modified object to the user processing system 2000.

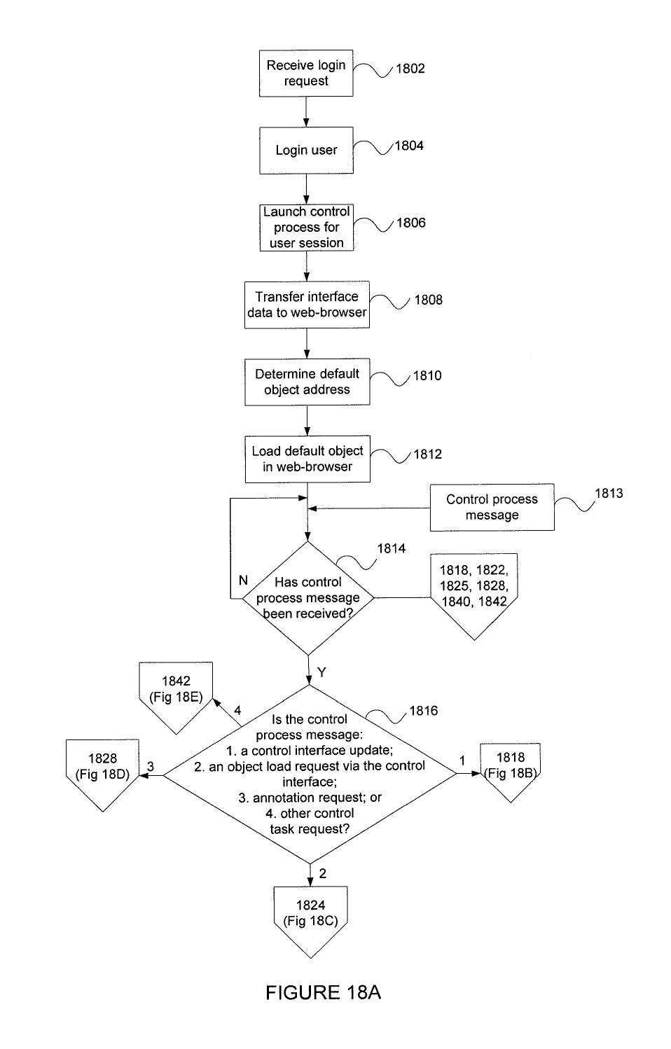

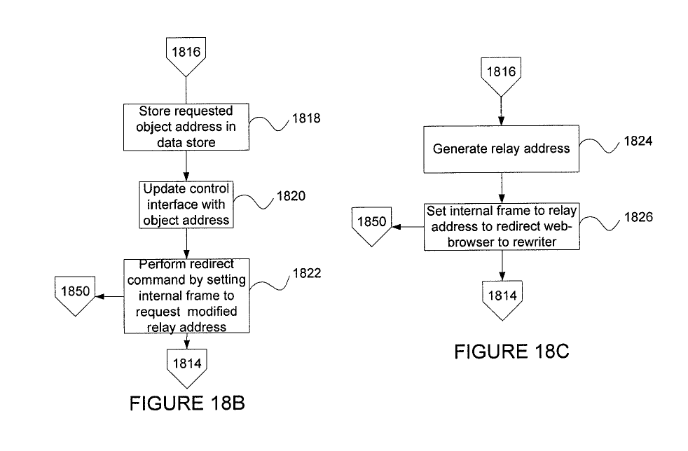

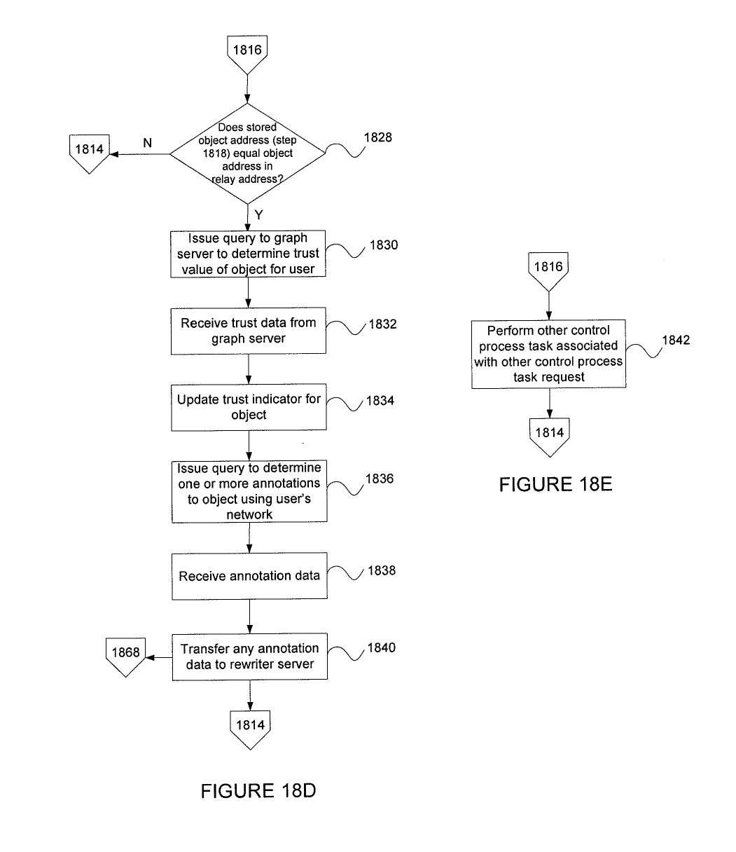

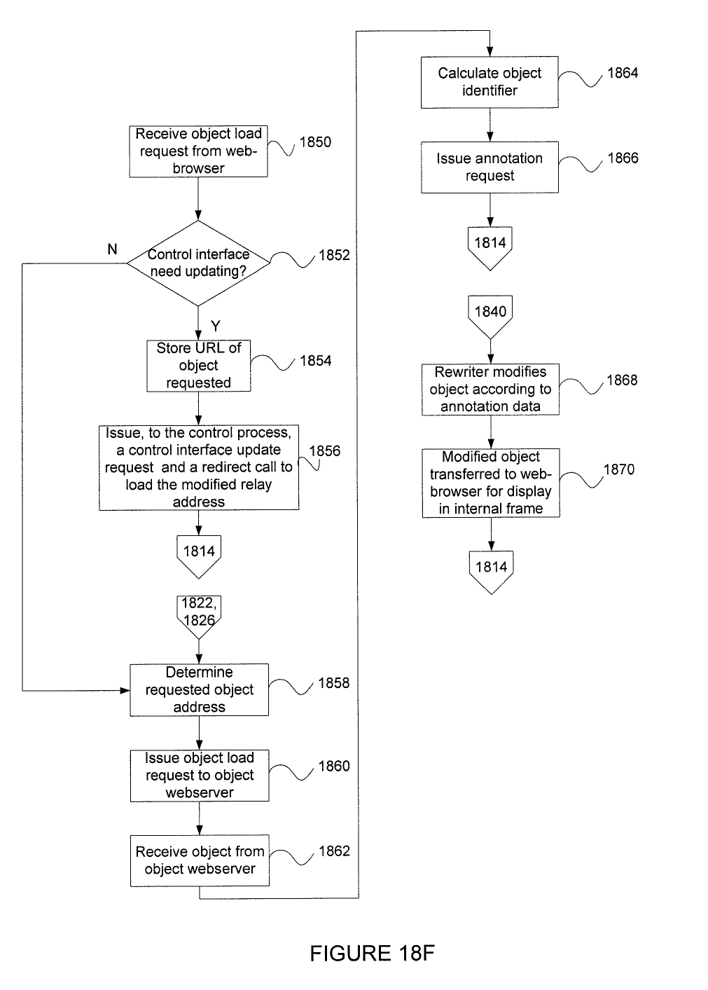

Referring to FIGS. 18A through to 18F, there is shown an example of a method 1800 of determining an attribute of an information object using the computerised system 1600 of FIG. 16. Specifically, FIG. 18A through to 18E represents a portion of the method performed by the control server 1610 and FIG. 18F represents a portion of the method performed by the rewriter server 1620. The example method 1800 described in relation to FIGS. 18A through to 18F is in relation to presenting web-based information content 1720, such as a webpage, via a web-browser 1700. However, it will be appreciated that the object may be of different formats and that this example is simply provided for the purposes of clarity.

The method 1800 described in relation to FIGS. 18A to 18F utilises a relay address in order to synchronise the first and second interface portions 1710, 1720. In this particular example, the relay address is a URL provided in the form of a sub-domain of the rewriter server 1620 to ensure that a GET command performed in relation to a relay URL results in the command being relayed via the rewriter server 1620. The relay URL can include a predefined format including a number of portions. In particular, the relay URL includes the URL of the rewriter server 1620. Additionally, the relay URL includes a process identifier indicative of a control process launched by the control server 1610 for servicing the user, as will be discussed in more detail later. The relay URL also includes the URL of the object requested. Furthermore, the relay URL can also include a control interface tag indicative of whether the control interface requires the presentation of the object URL for the object requested. The relay URL can be a string including a plurality of concatenated portions which are described above and concatenated in a predefined format stored at the control server and the rewriter server. In particular instances where a hyperlink is clicked in the web browser 1700, the control interface 1710 requires updating, however, in other instance where a script is being executed, the control interface 1710 does not require updating. Therefore, the presence of the control interface tag in the relay URL can be used to determine if the control interface 1710 requires updating.

Referring firstly to FIG. 18A, the method 1800, at step 1802, includes the control server 1610 receiving a login request from a user processing system 2000 operated by a user of the computerised system 1600. The login request is typically issued via a web-browser 1700 of the user processing system 2000.

At step 1804, the method 1800 includes the control server 1610 logging the user in using login data received from the user processing system 2000. In the event that the login data provided by the user is incorrect, the user is restricted from using the computerised system 1600 and method. The control server 1610 may pass the login information to the user information server to determine if the login request is successful.

At step 1806, the method 1800 includes the control server 1610 launching a control process to service a user session for the user. The control process can be provided in the form of a Comet process, however other forms of process can be launched. When the control server 1610 launches the control process, the control process is assigned a control process identifier. The control process identifier is used to keep the state of the control interface 1710 in synchronisation with the internal frame 1720 for the particular user session.

At step 1808, the method includes the control process transferring interface data to the user's web-browser 1700 via the web-server 1612 of the control server 1610. As previously mentioned, the interface data can include a first interface portion 1710 provided in the form of a container frame and a second interface portion 1720 provided in the form of an internal frame.

At step 1810, the method includes the control process determining a default object address to present. This can include querying the user information database via user information server 1640 to obtain the default object address. In this current example, the default object address is a URL.

At step 1812, the control process requests loading of a default object by the control interface 1710 of the web-browser 1700. In particular, the URL input field 1712 of the first interface portion 1710 displays the URL of the default object and the second interface portion 1720 displays the content of the default object. For the purposes of clarity, the default object displayed within the web-browser 1700 has been modified by the rewriter server 1620, in accordance with the method described herein, such that in the event that the user interacts with the default object thereby requesting a new object to be loaded within the web-browser 1700, such as for example clicking a hyperlink, the request is relayed via the rewriter server 1620.

At step 1814, the control process waits until a control process message is received as shown by step 1813. This is represented in the flowchart by a continuous loop as shown in FIG. 18A. The continuous loop represents an interrupt, as shown by step 1813, commonly used in software and hardware systems. As is shown in FIG. 18A, once a control process message is received, the method proceeds to step 1816.

At step 1816, the method 1800 includes the control process determining the type of control process message received to determine what action should be taken by the control process. In particular, the control process determines whether the control process message is: a control interface update request; an object load request via the control interface; an annotation request; or an alternate control task request.

In the event that the control process message is a control interface update request, the method proceeds to step 1818 in FIG. 18B. In the event that the control process message is an object load request via the control interface, the method proceeds to step 1824 of FIG. 18C. In the event, that the control process message is an annotation request, the method proceeds to step 1828 in FIG. 18D. In the event that the control message is an alternate control task request, the method proceeds to step 1842 of FIG. 18E.

Referring to step 1818 of FIG. 18B, the method 1800 includes the control process storing the requested object address in the data store of the control server 1610. The control interface update request can be indicative of the object address and thus the control process can obtain the object address using the control interface update request.

At step 1820, the method 1800 includes the control process updating the control interface with the object address. In the instance of the object being a website, this would include updating the URL input field with the URL of the website requested to be loaded.

At step 1822, the method 1800 includes the control process issuing a redirect call to the web-browser 1700 at the user processing system 2000, wherein the redirect call includes a relay URL pointing to the rewriter server 1620. Generally, the control process generates a modified relay address based upon the object request indicated by the control interface update request. In particular, the modified relay address lacks the presence of a control interface update portion due to the control interface being updated at step 1820.

The control process proceeds back to step 1814 to continue waiting for a further control process message. However, the method proceeds to step 1850 of FIG. 18F due to the redirect call be issued to the web-browser 1700, wherein step 1850 relates to the rewriter performing the rewriting process. FIG. 18F will be discussed in more detail later.

Referring back to FIG. 18A, in the event that the control process message is an object load request via the control interface, the method proceeds to step 1824 of FIG. 18C. Referring to FIG. 18C, the method includes, at step 1824, the control process generating a relay address based upon the object address. For example, in the event that the object address is a website, the relay address may be a sub-domain URL of the rewriter.

At step 1826, the method includes setting the internal frame 1720 of the web-browser 1700 to load the object located at the relay address generated in step 1824. The method then proceeds to step 1850 of FIG. 18F. As mentioned above, FIG. 18F will be discussed in detail below.

Referring back to FIG. 18A, in the event that the control process message is an annotation request, the method proceeds to step 1828 in FIG. 18D. Referring to FIG. 18D, the method includes comparing the object address stored in step 1818 to the object address which forms part of the annotation request received in step 1816. In effect, this comparison is performed to determine if the control interface 1710 needs to be updated. In some instances an object may include a number of sub-objects which are each loaded in the similar manner as described in relation to FIGS. 18A to 18F. However, only the rating value for the parent object is required to be calculated. In the event of a negative determination, the control process proceeds back to step 1814. In the event of a positive determination, the method proceeds to step 1830.

At step 1830 the method 1800 includes the control process issuing a query to the graph server 1630 to determine rating data for the object. The rating data can include a previously stored rating by the user of the object. Additionally or alternatively the rating data can include a calculated rating value based upon the user's network as previously described above.

At step 1832, the control process receives rating data indicative of a rating value previously submitted by the user and/or a calculated rating value for the object based upon the user's network.

At step 1834, the control process issues a control interface update request to the web-browser 1700 of the user processing system 2000 to update the control interface 1710, specifically the rating graphic 1718, 1719, to present the rating value(s) to the user via the web-browser. As mentioned, the rating graphic 1718, 1719 may be controlled to present a graphical representation of the rating value(s).

At step 1836, the method 1800 includes the control process querying the user information server 1640 and the graph server 1630 to determine if one or more annotations to be implemented to the object. This step can include determining one or more possible annotations submitted to the computerised system 1600 by members of the user's network, or potentially indirect members of the user's network as has been described earlier. As the graph server indicates a user's degree of trust of particular members of the user's network, annotations submitted by members of the network can be given varying weight in order to determine the appropriate annotations to be implemented to the object for the user.

In one form, in order to increase the speed at which the annotation data can be calculated, a portion of the user's network may only be used by the graph server. In one form the portion of the user's network may be one or more direct neighbour members in the user's network.

At step 1838, the control process receives annotation data indicative of any annotations required to be implemented to the object.

At step 1840, the method 1800 includes the control process transferring the annotation data indicative of the object and any annotations to be implemented to the object by the rewriter server 1620. The control process then returns to step 1814 to wait for another control process message. As a result of step 1840, the method then proceeds to step 1868 of FIG. 18F which will be discussed in more detail below.

Referring back to FIG. 18A, in the event that the control process message is an alternate control task request, the method proceeds to step 1842 of FIG. 18E. In particular, the method includes performing the alternate control task associated with the alternate control task request. The control process then returns to step 1814 to wait for another control process message.

Referring to FIG. 18F, this portion of the method is performed by the rewriter server. In particular, the method starts at step 1850 wherein the rewriter server 1620 receives an object load request. This request can be in response to a user selecting a hyperlink of a webpage, wherein the target address of the hyperlink is a relay address relayed to the rewriter server 1620. However, the object load request can be received via alternate means, such as the control process transferring a relay address to the web-browser to load which results in the object load request being issued to the rewriter server 1620.

At step 1852, the method includes the rewriter server 1620 determining if the control interface requires updating as a result of receiving the object load request. As specified above, the format of the relay URL can include a control interface tag. Specifically, the control interface tag can be provided as a prefix for the relay address which indicates to the rewriter whether the control interface requires updating for the particular object requested. A lack of the prefix in the relay address indicates that the control interface requires no updating.

In response to a negative determination to step 1852, the method proceeds to step 1858 which will be discussed later. Otherwise, the method proceeds to step 1854 wherein the rewriter determines and stores, in the rewriter data store, the address of the object requested.

At 1856 the method includes the rewriter issuing an update control interface request to the control process. The update control interface request can be indicative of the control process identifier, and the object address. The method then proceeds back to step 1814 wherein the control process receives the control process message in the form of an update control interface request. As discussed above, the method proceeds to step 1818 of FIG. 18B as discussed above. The result of performing the flowchart portion as indicated in FIG. 18B results in the method proceeding from step 1822 to step 1858 of FIG. 18F.

At step 1858, the rewriter server 1620 determines the object address using the modified relay address received from the web-browser 1700 which includes the object address.

At step 1860, the method includes the rewriter server 1620 issuing a load object request to the web-server hosting the object at the object address.

At step 1862, the method includes receiving the object from the hosting webserver.

At step 1864, the method includes the rewriter server 1620 determining an object identifier for the object. In a preferable form, the rewriter server 1620 calculates an object identifier in the form of a hash value indicative of the object. In one form, the object identifier may be a SHA-1 hash of at least a portion of the object. In another form, the rewriter server 1620 may calculate the hash value based upon only a portion of the object. The rewriter server 1620 may strip non-displayable information from the object to calculate the hash value, wherein in this instance the hash value is indicative of displayable information of the object. More specifically, the rewriter server 1620 may strip non-textual information and calculate the SHA-1 value based on the textual information of the object.

At step 1866, the method includes the rewriter server 1620 transferring an annotation request to the control process. In particular, the annotation request is indicative of the object address and the object identifier indicative of the object. The method then proceeds back to step 1814 wherein the control process receives a control message portion in the form of the annotation request issued in step 1866. As described previously, the method proceeds to step 1828 of FIG. 18D. The result of performing the flowchart portion of the method illustrated in FIG. 18D results in the method proceeding from step 1840 to step 1868 of FIG. 18F.

At step 1868, the method includes the rewriter server 1620 modifying the object according to the annotation data and one or more rewriter rules stored within a data store of the rewriter server 1620. For example, in the event that the object is a webpage including a number of hyperlinks pointing toward a hosting webserver, the rewriter server 1620 can modify each hyperlink such that the target address of the hyperlink is a relay URL pointing toward the rewriter server 1620. The rewriter server 1620 may also modify the object in order to intercept particular user activity via the web-browser 1700. For example, one or more scripts, such as one or more javascript functions or the like, may be introduced into the object in order to modify a contextual menu presented to the user via the web-browser 1700 when a right-mouse button click is performed in order to allow the user to submit annotations to the object presented in the web-browser 1700. Annotations are then stored by the computerised system using an object identifier calculated as discussed above.

At step 1860, the modified object is transferred to the web-browser 1700 for presentation to the user via the second interface portion 1720. The method then proceeds back to step 1814 wherein the rewriter server 1620 waits for the next object load request to be issued.

As discussed in relation to step 1868, the rewriter server 1620 includes a number of rewriter rules for modifying the object. For example, in the event that the object is a web-page, a number of rules are applied by the rewriter server 1620 to the object to modify the source code of at least some of the object. In particular, the rewriter rules for this type of object format can include, for example:
An anchor reference, a meta refresh tag, or a form action attribute is converted into relay URL which includes a control interface update tag;
‘src’ attributes are converted into a relay URL without including the control interface update tag;
Any hardcoded references to a target domain in javascript are converted into a relay URL without including the control interface update tag;

As discussed in relation to step 1868, one or more scripts may be injected into the source code of an object in order to intercept user interactions with the loaded object. However, the process of injecting scripts into an object can be performed by the rewriter server 1620 for one or more other instances. In particular, a script can be injected into the object in order to intercept the selection by the user of anchors, wherein the injected script rewrites the ‘href’ attribute in the event that the ‘href’ attribute does not point toward the rewriter server 1620. In another instance, a script can be injected into the object in order to intercept a form ‘submit’ event for a form, wherein the injected script rewrites the action attribute of the form in the event that the form ‘submit’ event does not point toward the rewriter server 1620. These two instances of injecting scripts into the object can be used to ensure that AJAX-generated content does not include references that could cause the user's browser to be directed away from the rewriter server 1620.

In an optional form, a member of the user's network does not necessarily need to be a human. In one form, the member could be a computer entity, such as Google Pagerank which provides a ranking of the importance or trustworthiness of the information object. A user may then select the computer entity as a user of the user's network, and submit a degree of trust to the computerised system in relation to the computer entity such that the rating presented by the computerised system to the user is potentially at least partially based upon the rating of the attribute of the information object provided by the computer entity.

Enhancements possible with this invention include making use of a subset of the recorded relationships to provide a global estimate of reliability, and making use of a derived global estimate of reliability to re-rank external search results according to their estimated veracity.

As will be appreciated, a computer program product may be provided for implementing the above method and system described. The computer program product can include one or more programs for execution by one or more processors of a computerised system The computer program product can be provided in the form of a web-based application that can be accessed by a user processing system via the Internet. Additionally or alternatively, the computer program product can be provided as a computer readable medium which refers to any storage or transmission medium that participates in providing instructions and/or data to the computer system 100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the processing system 100. Examples of transmission media include radio or infra-red transmission channels as well as a network connection to another computer or networked device, and the Internet or Intranets including e-mail transmissions and information recorded on Websites and the like.

As a computerised system has been herein described, it will be appreciated that the steps described herein can be performed by the processor of the respective processing system associated with the respective step. Steps which involve storage of data can be performed by the respective processor storing data in the respective data store(s), such as memory or a database, for the respective processing system. Steps which involves the retrieval of data can be performed by the respective processor retrieving the stored data from the respective data store(s), such as memory of a database, for the respective processing system.

Many modifications will be apparent to those skilled in the art without departing from the scope of the present invention.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1. A system for presenting an information object to a requesting user, the system including a computerised system configured to:
receive, from one or more users, attribute data indicative of a personal estimate of an attribute of the information object;
receive, from at least some of the users, trust data indicative of a degree to which the respective user trusts one or more other users using the computerised system;
receive, from a requesting user whom is one of the one or more users, a request to be presented the information object;
determine, based upon the attribute data and the trust data, annotation data for annotating the information object; and
modify the information object according to the annotation data for presentation to the requesting user.

2. The system according to claim 1, wherein the computerised system receives, from the requesting user, network selection data to define a user network representing a selection of the one or more users of the computerised network, wherein the user network is used by the computerised network to determine the annotation data for modifying the information object for the requesting user.

3. The system according to claim 2, wherein trust data received from one or more users selected in the requesting user's user network are used to indirectly determine the annotation data for modifying the information object for the requesting user.

4. The system according to claim 2, wherein the computerised system is configured, in response to receiving the request to present the information object from the requesting user, to:
determine a rating of the information object based upon the trust data and the personal estimate of the attribute of the information object received from at least some of the one or more users of the requesting user's user network; and
present the rating of the object to the requesting user.

5. The system according to claim 4, wherein the computerised system is configured to determine the rating of the information object using trust data and one or more personal estimates received from one or more indirect users defined within one or more user networks of one or more users selected within the requesting user's user network.

6. The system according to claim 1, wherein the computerised system receives the trust data and the attribute data via one or more user processing systems in data communication with the computerised system.

7. The system according to claim 6, wherein the computerised system includes:
a rewriter server configured to modify the information object according to the annotation data; and
a web server, in data communication with the rewriter server, which transfers data indicative of the information object, as modified by the rewriter server, to the requesting user via a web-browser being used at the respective user processing system of the requesting user.

8. A method for presenting an information object to a requesting user, the method being performed by a computerised system, wherein the method includes, in the computerised system:
receiving, from one or more users, attribute data indicative of a personal estimate of an attribute of the information object;
receiving, from at least some of the users, trust data indicative of a degree to which the respective user trusts one or more other users using the computerised system;
receiving, from a requesting user whom is one of the one or more users, a request to be presented the information object;
determining, based upon the attribute data and the trust data, annotation data for annotating the information object; and
modifying the information object according to the annotation data for presentation to the requesting user.

9. The method according to claim 8, wherein the method includes, the computerised system, receiving, from the requesting user, network selection data to define a user network representing a selection of the one or more users of the computerised network, wherein the user network is used by the computerised network to determine the annotation data for modifying the information object for the requesting user.

10. The method according to claim 9, wherein the method includes the computerised system, using trust data received from one or more users selected in the requesting user's user network to indirectly determine the annotation data for modifying the information object for the requesting user.

11. The method according to claim 9, wherein in response to receiving the request to present the information object from the requesting user, the method includes the computerised system:
determining a rating of the information object based upon the trust data and the personal estimate of the attribute of the information object received from at least some of the one or more users of the requesting user's user network; and
presenting the rating of the object to the requesting user.

12. The method according to claim 11, wherein the method includes the computerised system determining the rating of the information object using trust data and one or more personal estimates received from one or more indirect users defined within one or more user networks of one or more users selected within the requesting user's user network.

13. The method according to claim 8, wherein the method includes the computerised system receiving the trust data and the attribute data via one or more user processing systems in data communication with the computerised system.

14. The method according to claim 13, wherein the computerised system includes a rewriter server in data communication with a web server, wherein the method includes:
the rewriter server modifying the information object according to the annotation data; and
the web server transferring information object data indicative of the information object, as modified by the rewriter server, to the requesting user via a web-browser being used at the user processing system by the requesting user.

15. A computer program product including one or more programs for execution by one or more processors of a computerised system, wherein execution of the one or more programs enables the computerised system to present an information object to a requesting user, wherein the one or more programs includes instructions for:
receiving, from one or more users, attribute data indicative of a personal estimate of an attribute of the information object;
receiving, from at least some of the users, trust data indicative of a degree to which the respective user trusts one or more other users using the computerised system;
receiving, from a requesting user whom is one of the one or more users, a request to be presented the information object;
determining, based upon the attribute data and the trust data, annotation data for annotating the information object; and
modifying the information object according to the annotation data for presentation to the requesting user.

16. The computer program product according to claim 15, wherein the computer program product configures the computerised system to receive, from the requesting user, network selection data to define a user network representing a selection of the one or more users of the computerised network, wherein the user network is used by the computerised network to determine the annotation data for modifying the information object for the requesting user.

17. The computer program product according to claim 16, wherein the computer program product configures the computerised system to use trust data received from one or more users selected in the requesting user's user network to indirectly determine the annotation data for modifying the information object for the requesting user.

18. The computer program product according to claim 16, the computer program product configures the computerised system to, in response to receiving the request to present the information object from the requesting user:
determine a rating of the information object based upon the trust data and the personal estimate of the attribute of the information object received from at least some of the one or more users of the requesting user's user network; and
present the rating of the object to the requesting user.

19. The computer program product according to claim 18, wherein the computer program product configures the computerised system to determine the rating of the information object using trust data and one or more personal estimates received from one or more indirect users defined within one or more user networks of one or more users selected within the requesting user's user network.

20. The computer program product according to claim 15, wherein the computer program product configures the computerised system to receive the trust data and the attribute data via one or more user processing systems in data communication with the computerised system.
